(19) United States
(12) Patent Application Publication
(10) Pub. No.: US 2015/0067582 A1
(43) Pub. Date: Mar. 5, 2015

(54) CONTENT NAVIGATION STRUCTURE AND TRANSITION MECHANISM

(71) Applicant: Storehouse Media, Inc., San Francisco, CA (US)

(72) Inventors: Timothy Donnelly, San Francisco, CA (US); Mark Kawano, San Mateo, CA (US)

(73) Assignee: Storehouse Media, Inc., San Francisco, CA (US)

(21) Appl. No.: 14/018,726

(22) Filed: Sep. 5, 2013

(51) Int. Cl. G06F 3/0481; G06F 3/0488; G06F 3/0485

(52) U.S. Cl. CPC G06F 3/04817; G06F 3/0485; G06F 3/0488
USPC 715/784; 715/800

(57) ABSTRACT

A method of content presentation on a device is disclosed. The method includes: presenting a media presentation structure through a view window on a display screen of the device, wherein the media presentation structure includes multiple presentation layers; detecting a navigation command through an input stream from an input hardware of the device, wherein the navigation command enables the view window to traverse through presentation of a first presentation layer of the media presentation structure; determining when the navigation command indicates a layer transition from the first presentation layer to a second presentation layer by determining whether the navigation command exceeds a limit of the first presentation layer; and rendering a transition sequence of the layer transition when the layer transition is indicated.

### TECHNICAL FIELD

The disclosure relates generally to a content navigation mechanism, and in particular to a graphical user interface for navigating through a content presentation structure.

### INTRODUCTION

Digital media content has become pervasive, overshadowing the traditional mediums of content delivery, such as books, magazines, newspaper, comic books, video tapes, DVDs, other types of traditional media. The medium through which digital media content can be delivered is often an electronic device. The electronic device, especially mobile devices, enables much broader spectrum of presentational freedom, enabling presentation of videos, audio clips, images, text, widgets, embedded applications, or any combination thereof. However, presentational freedom may come at the cost of confusing the users of the electronic device. Hence there is a need for a content presentation structure to organize the media elements and a way of navigating through such content presentation structure.

### DISCLOSURE OVERVIEW

The disclosed technology involves a method of navigating through a content presentation structure on a display device enabling a user to smoothly transition between layers within the content presentation structure. For example, the transition may include a transition from a content container layer to a container shelf layer or vice versa. For example, the content container may be a continuously navigable interface presenting arranged media objects and the container shelf may be a continuously navigable interface presenting content containers. Each content container may be represented by a cover in the container shelf. Each content container may also begin its navigable interface with the cover as a first media element to be presented.

In various embodiments, the content presentation structure includes the container shelf layer enabling a serial navigation of content containers in a first dimension, and the content container layer enabling a serial navigation of arranged media content in a second dimension. The second dimension and the first dimension may be orthogonal to one another.

As an example, the technology enables rendering of a transition sequence between the content container layer and the container shelf layer when a transition trigger is detected based on a user input to the display device. For example, the display device may be an electronic device coupled to a touch panel component. The transition trigger may include a gesture detected by the touch panel component over a specific object in the content presentation structure. The transition trigger may include detecting a gesture intended to zoom or scroll through a portion of the content presentation structure, where the zooming or scrolling would take the user interface beyond a boundary of the content presentation structure.

The transition sequence may include a static or dynamic (e.g., coupled to the user input/gesture) animation. For example, the transition sequence may include an animated sequence of the cover of the content container in question. The animated sequence may include a tilting of the cover, a size reduction or enlargement of the cover, a sliding in of the cover, or any combination thereof.

The disclosed content presentation structures and presentation layer transition mechanisms are advantageous in providing users with intuitive navigation of contents. For example, the transition mechanisms and the content presentation structures described enable a convenient interface for users to browse through arranged contents.

Some embodiments of the invention have other aspects, elements, features, and steps in addition to or in place of what is described above. These potential additions and replacements are described throughout the rest of the specification

### BRIEF DESCRIPTION OF THE DRAWINGS

FIG. 1A is an illustration of a screen window of an electronic device illustrating a container shelf layer in a content presentation structure, consistent with various embodiments.

FIG. 1B is an illustration of a screen window of the electronic device illustrating a content container layer in the content presentation structure, consistent with various embodiments.

FIG. 2 is a screenshot of a screen window of an electronic device showing a frame in a transition sequence between layers in the content presentation structure, consistent with various embodiments.

FIG. 3 is a control flow diagram of an electronic device with a touch panel component, consistent with various embodiments.

FIGS. 4A-4D are screen shots of a graphical user interface displayed on an electronic device illustrating navigation through a content presentation structure, consistent with various embodiments.

FIGS. 5A-5D are sequential images of the graphical user interface displayed on an electronic device illustrating a transition sequence from a container shelf layer to a content container layer of a content presentation structure, consistent with various embodiments.

FIGS. 6A-6E are sequential images of the graphical user interface displayed on an electronic device illustrating a transition sequence from a content container layer to a container shelf layer of a content presentation structure, consistent with various embodiments.

FIGS. 7A-7E are sequential images of the graphical user interface displayed on an electronic device illustrating another transition sequence from a content container layer to a container shelf layer of a content presentation structure, consistent with various embodiments.

FIG. 8 is a block diagram of a content presentation system including an electronic device and one or more data sources, configured in accordance with various embodiments.

FIG. 9 is a flow chart illustrating a method of navigating through a content presentation structure, consistent with various embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Disclosed is a technology that implements a mechanism for transitioning between presentation layers in a content presentation structure. The content presentation structure is utilized to present digital media content on an electronic device as a structured media presentation interface. In various embodiments, the content presentation structure is organized in a hierarchical structure of presentation layers. The hierarchical structure enables the mechanism for transitioning between a lower level layer and an upper level layer.

Users may navigate through each presentation layer to observe elements of the presentation layer, and transition between the presentation layers by triggering a mechanism for transitioning. The electronic device can be a computing device coupled with a display. For example, the electronic device can be a laptop, a smart phone, a desktop computer, a tablet, an e-reader, a smart watch, or other digital display. The electronic device can further be coupled to a touch pad to detect trigger conditions through user interaction for the transitioning mechanisms.

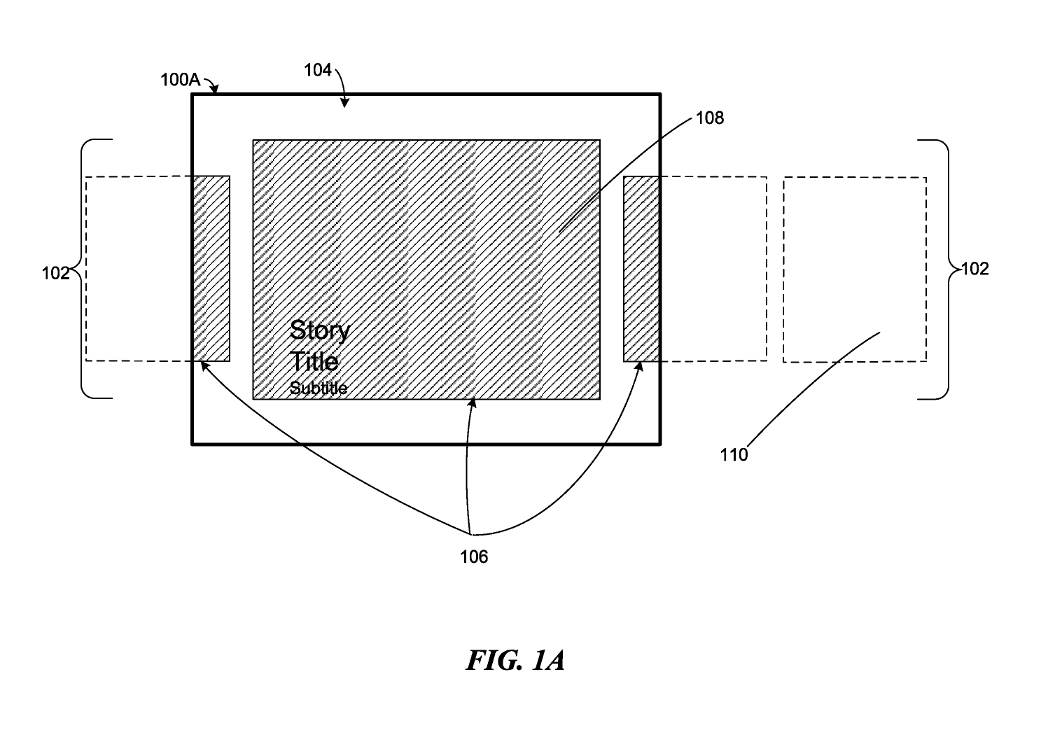

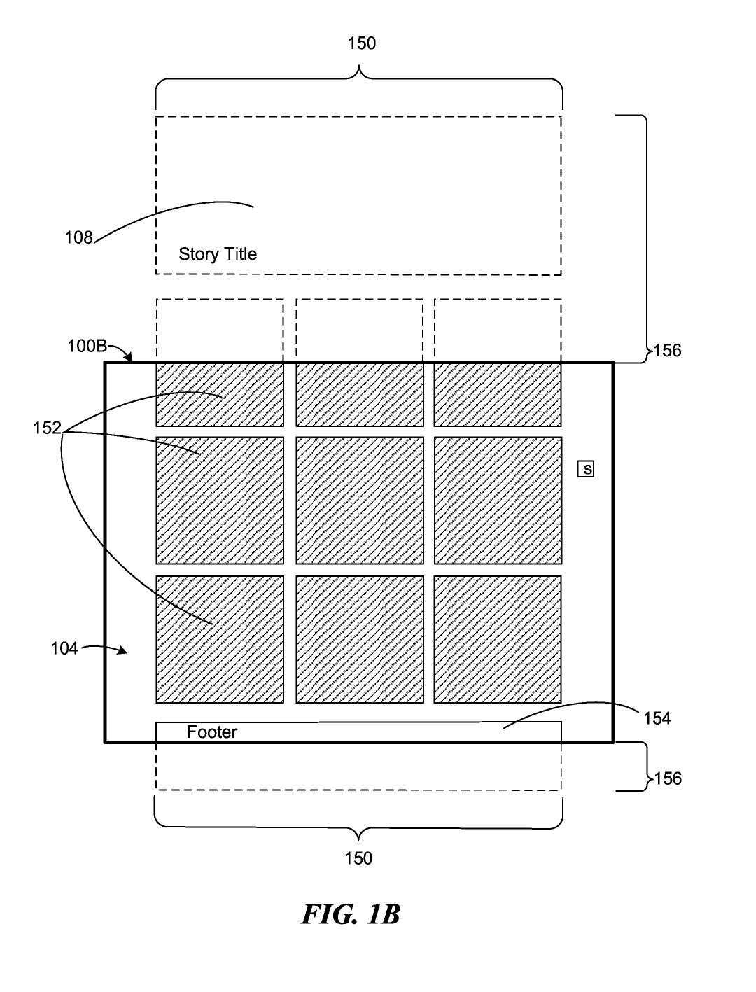

FIG. 1A is an illustration of a screen window 100A of an electronic device illustrating a container shelf layer 102 in a content presentation structure 104, consistent with various embodiments. The screen window 100A may be a display screen or a portion thereof of the electronic device. The content presentation structure 104 is navigable through the display and a user input component of the electronic device. The content presentation structure 104 may include multiple layers, including the container shelf layer. In various embodiments, when the content presentation structure 104 is not in a transition state, the content presentation structure 104 can display only a single presentation at a time on the screen window 100A of the electronic device.

The container shelf layer 102, as illustrated, is a visualization of a list of content containers, where each may be opened up by a user to access its contents. In some embodiments, the container shelf layer 102 is a horizontal strip of content containers 106. A content container 106 is represented in the container shelf layer 102 by its cover 108. A cover may be a still image or a video clip.

In various embodiments, a user may navigate through the container shelf layer 102 by traversing along a horizontal direction. Traversal along the horizontal direction may be achieved by user inputs, such as a sliding motion (e.g., horizontal sliding) on a touchscreen of the electronic device, a click of a button on the electronic device (e.g., a cursor button, or a left or right arrow on a keyboard), a voice command through a microphone of the electronic device, a gesture in air as observed by a camera of the electronic device, a dragging motion through a user cursor device (e.g., a mouse or a joystick), or any combination thereof.

When a content container is at the center of the screen window 100A, the cover 108 of the content container may be emphasized. For example, the cover 108 may be emphasized through an expansion that makes the centered cover 108 larger than peripheral content containers.

The content presentation structure 104 enables the container shelf layer 102 to exist beyond the size of the screen window 100A. For example, as illustrated, concealed shelf portions 110 are illustrated in FIG. 1A as broken lines. A concealed shelf portion 110 is not shown on the screen window 100A until a traversal of the container shelf layer 102 is detected, and thus moving the conceal container portion 110 into view. In various embodiments, a partial traversal of the container shelf layer 102 in which a cover 108 of a content container 106 is not centered on the screen window 100A would be extrapolated such that the closest cover 108 in the direction of the traversal is aligned to the center of the screen window 100A.

In various embodiments, the container shelf layer 102 may be presented in a virtualized three-dimensional space on the screen window 100A. The objects within the container shelf layer 102 may be rendered with one or more visual effects to appear within the three-dimensional space, such as shadowing, relative sizing, perspective distortion, contrasting, or other effects of making an object appear to rest in a three dimensional space, or any combination thereof. As an example, the cover 108 is rendered to be larger than other content containers to appear closer to the viewer of the screen window 100A.

FIG. 1B is an illustration of a screen window 100B of the electronic device illustrating a content container layer 150 in the content presentation structure 104, consistent with various embodiments. The screen window 100B may be the same display screen or the portion thereof as the screen window 100A showing a portion of the content presentation structure 104. The content container layer 150 may be an expanded navigable presentation of the content container 106.

The content container layer 150, as illustrated, is a compiled presentation of one or more media objects 152. The media objects 152 may include, for example, a video clip, a still image, a text confined within a geometry, an interactive application, an audio clip, or other media files. The content container layer 150 may resize any combination of its media objects 152 as a user navigates through the content container layer 150, such as when the user changes the position or zoom of the content container layer 150 with respect to the screen window 100B.

In various embodiments, the content presentation structure 104 is stored on the electronic device. In other embodiments, the content presentation structure 104 is stored on a content provider server system. The media objects may be cached on the electronic device or the content provider server system. The media objects may also be linked from a content source external to both the electronic device and the content provider server system.

A user may navigate through the content container layer 150 by traversing along a vertical dimension. Traversal along the vertical dimension may be achieved by user inputs, such as a sliding motion (e.g., vertical sliding) on a touchscreen of the electronic device, a click of a button on the electronic device, a voice command through a microphone of the electronic device, a gesture in air as observed by a camera of the electronic device, a dragging motion through a user cursor device (e.g., a mouse or a joystick), or any combination thereof.

The compiled presentation of the content container layer 150 may be sandwiched between a cover 108 at the top, and a footer 154 at the bottom. However, the screen window 100B can provide a limited view of the content presentation structure 104. Hence, the content container layer 150 can include concealed container portions 156. For example, the conceal container portions 156 are illustrated in FIG. 1B as broken lines. A concealed container portion 156 is not shown on the screen window 100A until a traversal of the content container layer 150 is detected and thus moving the concealed container portion 156 into view.

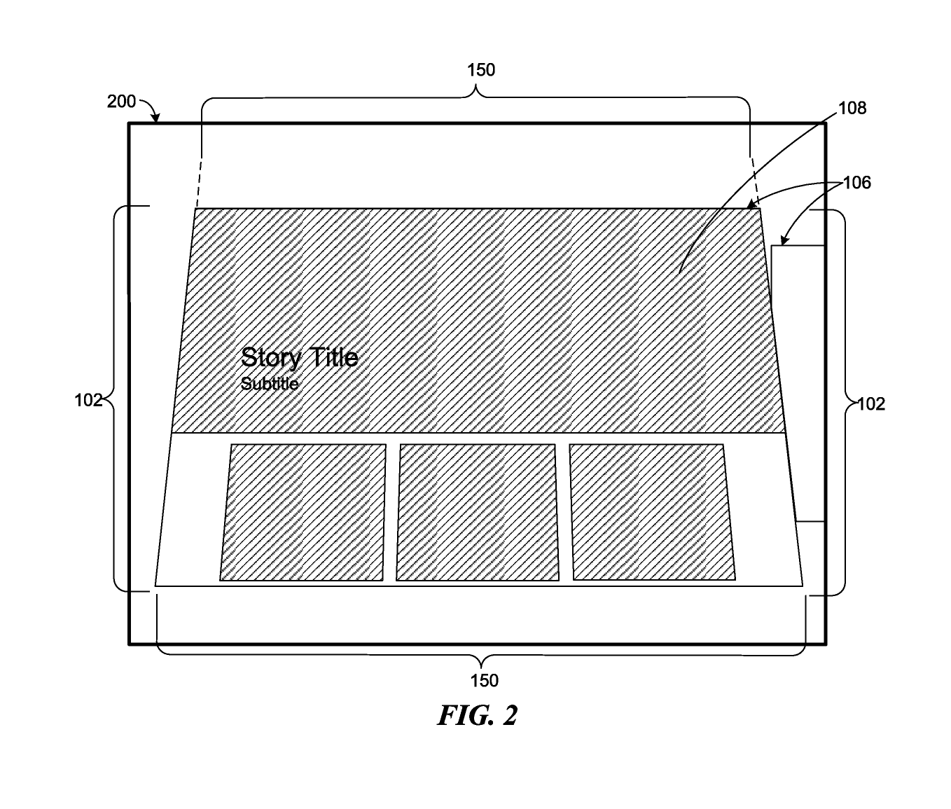

FIG. 2 is a screenshot of a screen window 200 of an electronic device showing a frame in a transition sequence between layers in a content presentation structure, such as the content presentation structure 104, consistent with various embodiments. The screen window 200, for example, can be the screen window 100A or 100B of FIG. 1A or FIG. 1B.

The electronic device may monitor for a transition trigger based on user interaction with the electronic device. In response to the transition trigger being detected, the electronic device may activate the transition sequence. For example, the transition trigger may include a determination of a traversal of a presentation layer beyond its limits (e.g., positional boundaries or zoom size thresholds). As another example, the transition trigger may include a zoom out beyond a size threshold. The traversal may be associated with a specific gesture (e.g., on a touch screen, via a mouse or other cursor, or as observed by a camera), one or more key presses, one or more cursor actions (e.g., dragging, swiping, or double clicking), or any combination thereof. In these examples, the gestures, key presses, or other inputs are associated with navigational commands, such as scrolling up or down, or zooming in or out. Each navigational commands may reach limits of the content presentation structure, such as scrolling up (e.g., by a downward swipe gesture on the touch screen) until there is no more content to scroll up from, or zooming out (e.g., by a pinch gesture on the touch screen) until a zoom size threshold is exceeded.

In some embodiments, the transition sequence may be a constant animation. In preferred embodiments, the transition sequence may be a feedback controlled animation. The feedback controlled animation is an animation sequence where user engagement is required for the entire or portions of the animation sequence. For example, where the transition trigger is a sliding motion on the touchscreen, the transition sequence may be coupled with the sliding movement of the user. The user may be required to keep sliding along a first dimension until the sliding movement of the user carries the transition sequence beyond a positional threshold.

For example, the transition sequence shown on FIG. 2 may be a transition from the container shelf layer 102 of FIG. 1A to the content container layer 150 of FIG. 1B or vice versa. In the example transition from the container shelf layer 102 to the content container layer 150, the transition sequence may include a tilting of a preview of the content container layer 150 (e.g., the cover 108 and/or first few media objects 152) into the screen window 200 in a three-dimensional virtual space, an expansion in size of the content container layer 150, an un-tilting of the content container layer 150, a traversal (e.g., scrolling down) of the content container layer 150 from the cover 108, or any combination thereof.

In this example, the tilting, expansion, un-tilting, and/or traversal may be coupled to a vertical sliding/swiping gesture detected on a touchscreen. The tilting may initiate as the user begin to slide, and the distance of the sliding may be coupled to the degree of tilting. Along the same lines, the expansion may also initiate as the user began to slide. The expansion may occur simultaneously or after the tilting animation effect. The amount of expansion may be coupled to the distance of the sliding. The un-tilting may initiate as the user begin to slide. The un-tilting may occur simultaneously as the expansion or the tilting, or after either the expansion or the tilting. Some amount of traversal down through the content container layer 150 may be triggered following the un-tilting. The amount of traversal may be coupled to the distance of the sliding. The transition trigger detection may include a distance threshold. When the amount of sliding exceeds the distance threshold, the transition sequence may play out regardless of whether the user continues the sliding gesture.

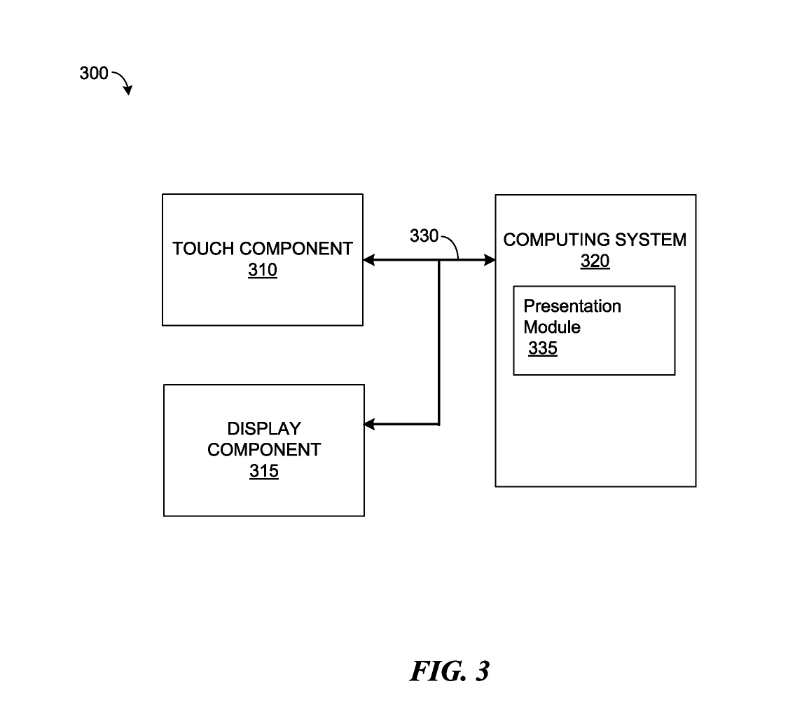

FIG. 3 is a control flow diagram of an electronic device 300 with a touch panel component 310, consistent with various embodiments. The electronic device 300, for example, may be the electronic device responsible for presenting the screen window in FIG. 1A, 1B, or 2. The touch panel component 310 may be a device adapted to receive touch input for interacting with a computing system 320 via a wired or wireless communication channel 330. The computing system 320 may be a processing device, such as a processor, or a plurality of processing devices working in unison, such as a cloud computing environment. The touch panel component 310 may be used to provide user input to the computing system 320 in lieu of or in combination with other input devices such as a keyboard, mouse, etc. One or more touch devices 310 may be used for providing user input to the computing system 320. The touch panel component 310 may be an integral part of the computing system 320 (e.g., touch screen on a tablet or a laptop) or may be separate from the computing system 320.

The touch panel component 310 may include a touch sensitive panel which is wholly or partially transparent, semitransparent, non-transparent, opaque or any combination thereof. The touch panel component 310 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensitive surface for receiving touch input.

The electronic device 300 may further include a display component 315. The display component 315 is adapted to communicate with the computing system 320, such as via the communication channel 330. The display components 320 may couple to the touch panel component 310 to act as an integral unit. In various embodiments, the touch panel component 310 and the display component 315 may be integrated with one another acting as a touch screen.

In one example, the touch panel component 310 embodied as a touch screen may include a transparent and/or semitransparent touch sensitive panel partially or wholly positioned over at least a portion of the display component 315. According to this embodiment, the display component 315 functions to display graphical data, such as the content presentation structure 104 of FIG. 1, transmitted from the computing system 320 (and/or another source), and the touch panel component 310 functions to receive user input.

In other embodiments, the touch panel component 310 may be embodied as an integrated touch screen where touch sensitive components/devices are integral with display components/devices, e.g., the display component 315. In still other embodiments, a touch screen (i.e., where the touch panel component 310 is integrated with the display component 315) may be used as a supplemental or additional display screen for displaying supplemental or the same graphical data as a primary display and to receive touch input.

The touch panel component 310 may be configured to detect the location of one or more touches or near touches on the touch panel component 310 based on capacitive, resistive, optical, acoustic, inductive, mechanical, chemical measurements, or any phenomena that can be measured with respect to the occurrences of the one or more touches or near touches in proximity to the touch panel component 310. Software, hardware, firmware or any combination thereof may be used to process the measurements of the detected touches to identify and track one or more gestures. A gesture may correspond to stationary or non-stationary, single or multiple, touches or near touches on the touch panel component 310. A gesture may be performed by moving one or more fingers or other objects in a particular manner on the touch panel component 310, such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

The computing system 320 may include a presentation module 335. The presentation module 335 is adapted to drive a display with graphical data to display a graphical user interface (GUI), such as the content presentation structure 104 illustrated in figures above. The GUI may be configured to receive touch input via touch panel component 310. The display component 315 may display and present the GUI.

The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on the touch panel component 310 that may be associated with the graphical elements of the GUI. In other embodiments, the user may perform gestures at one or more locations that are independent of the locations of graphical elements of the GUI. Gestures performed on the touch panel component 310 may directly or indirectly manipulate, control, modify, move, actuate, initiate or generally affect graphical elements such as cursors, icons, media files, lists, text, all or portions of images (e.g., such as elements in the content presentation structure discussed above and below in connection with figures of this disclosure), or the like within the GUI.

For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within the computing system 320 (e.g., affect a state or mode of a GUI, application, or operating system). Gestures may or may not be performed on the touch panel component 310 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other embodiments in which gestures are performed directly on a touch screen, a user may interact directly with objects on the touch screen, with or without a cursor or pointer being displayed on the touch screen.

Feedback may be provided to the user via the communication channel 330 in response to or based on the touch or near touches on the touch panel component 310. Feedback may be transmitted optically (e.g., a flash or a soft key animation in response to one or more touches), mechanically (e.g., a vibration in response to one or more touches), electrically, olfactory, acoustically (e.g., an audio tune in response to one or more touches), or the like or any combination thereof and in a variable or non-variable manner.

The system architecture of the electronic device 300 may be embodied within any portable or non-portable device including but not limited to a communication device (e.g., mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 300, including combinations of two or more of these types of devices.

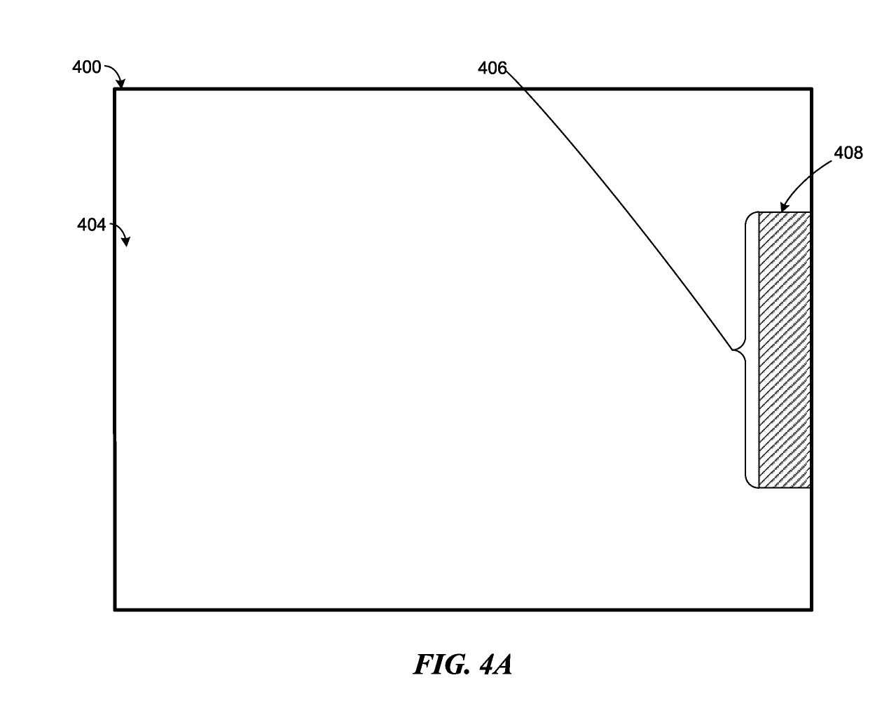

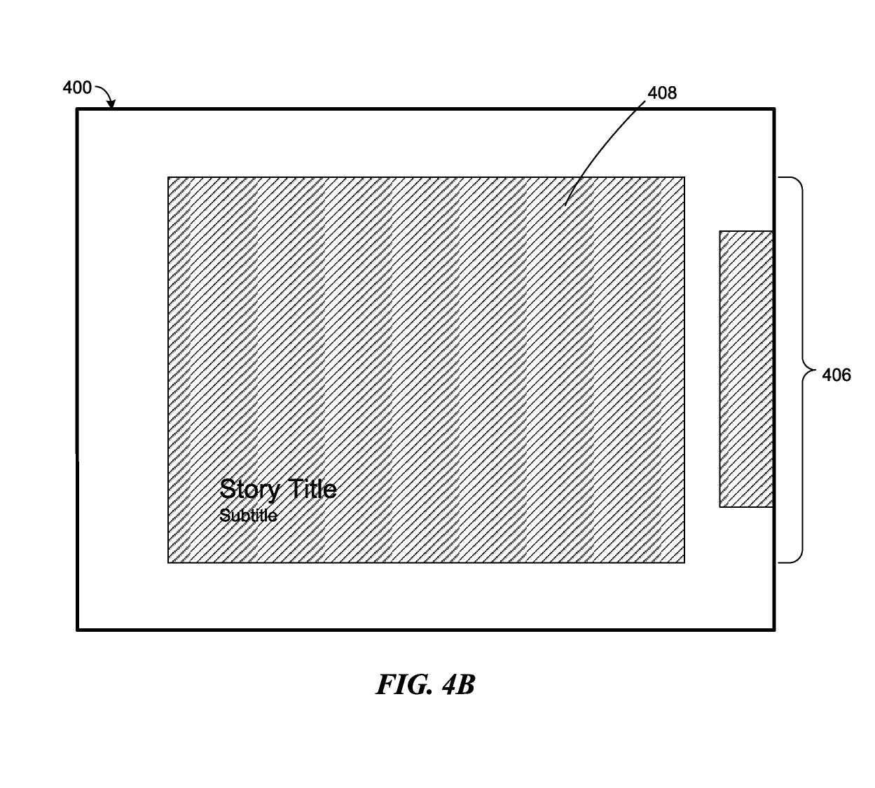

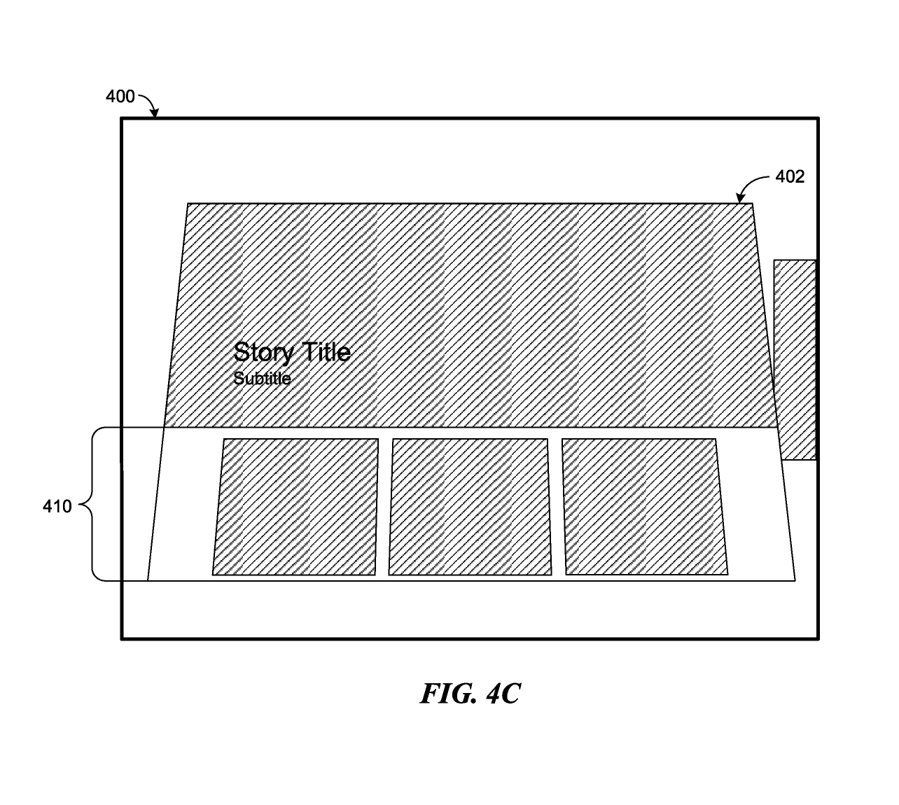

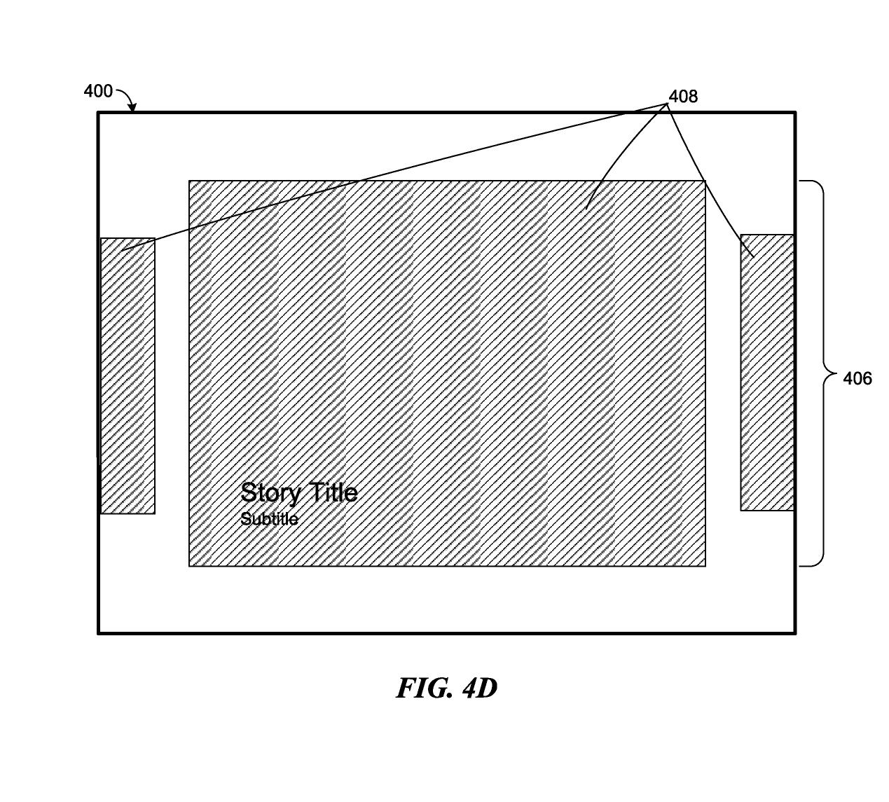

FIGS. 4A-4D are screen shots of a graphical user interface displayed on an electronic device illustrating navigation through a content presentation structure, such as the content presentation structure 104 of FIG. 1, consistent with various embodiments. For example, the display component can be the display component 315 of the electronic device 300. The GUI may be generated by the presentation module 335 of FIG. 3.

FIG. 4A illustrates a screen window 400 of the electronic device illustrating a title screen 404 of the GUI. The title screen 404 may include the beginning of a container shelf layer 406, such as the container shelf layer 102 of FIG. 1. In the illustrated title screen 404, the content shelf layer 406 lies on the right-hand side. In various embodiments, a user may navigate through the container shelf layer 406 by traversing along a horizontal dimension.

As an example, the user may make a horizontal swipe gesture on a touch panel component of the electronic device, such as the touch panel component 310 of FIG. 3. The horizontal swipe gesture may carry other parts of the container shelf layer 406, such as a content container 408, to the center of the screen window 402.

FIG. 4B illustrates the screen window 400 of the electronic device illustrating a portion of the container shelf layer 406. For example, FIG. 4B may illustrate the screen window 400 after the user makes a horizontal swipe gesture from the title screen 404 of the GUI. Similar to FIG. 1A, the content container 408 represented by a cover, such as the cover 108 of FIG. 1, is illustrated at the center of the screen window 400.

FIG. 4C illustrates the screen window 400 of the electronic device displaying a sneak preview 410 of the content container 408. The sneak preview 410 enables the user to view a portion of media objects, e.g., the media objects 152 of FIG. 1, within the content container 408 without fully transitioning to the content container layer, such as the content container layer 150 of FIG. 1B. The sneak preview 410 may be activated via a user interaction with the GUI.

As an example, a user can activate the sneak preview 410 by a swiping or sliding gesture. For example, in the swiping gesture for the sneak preview 410 may be along a dimension orthogonal to the horizontal swipe gesture used to traverse the container shelf layer 406. As a specific example, the user can swipe upwards on the content container 408 and thus scroll down along the content container 408. As the user swipes, but prior to reaching a threshold distance of the swipe, the GUI can show the sneak preview 410 of some or all of the media objects within the content container 408. In various embodiments, the media objects shown can be the first page of the content container layer after the cover.

FIG. 4D illustrates the screen window 400 of the electronic device displaying the container shelf layer 406 further traversal from a position in FIG. 4B. As illustrated, three content containers 408 are visible on the screen window 400. While the container shelf layer 406 may include more than three content containers 408, the screen window 400 of the GUI may limit the number of content containers 408 that can be shown on the screen window 400. As an example, the content container 408 in the center of the screen window 400 is emphasized, such as by enlarging the cover of the content container 408.

A user can select and emphasize different content containers 408, such as when the user intends to transition into the content container 408 or to take a sneak preview 410 of the content container 408. As an example, the user can select the left side content container 408 by swiping to the right on the touch component of the electronic device, and select the right side content container 408 by swiping to the left on the touch component.

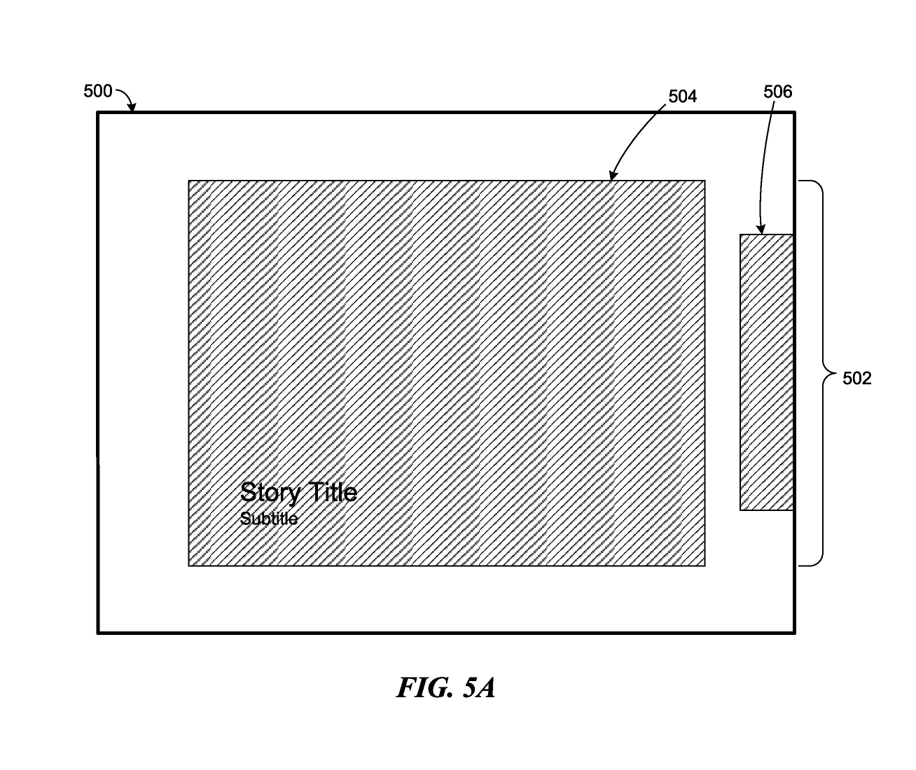

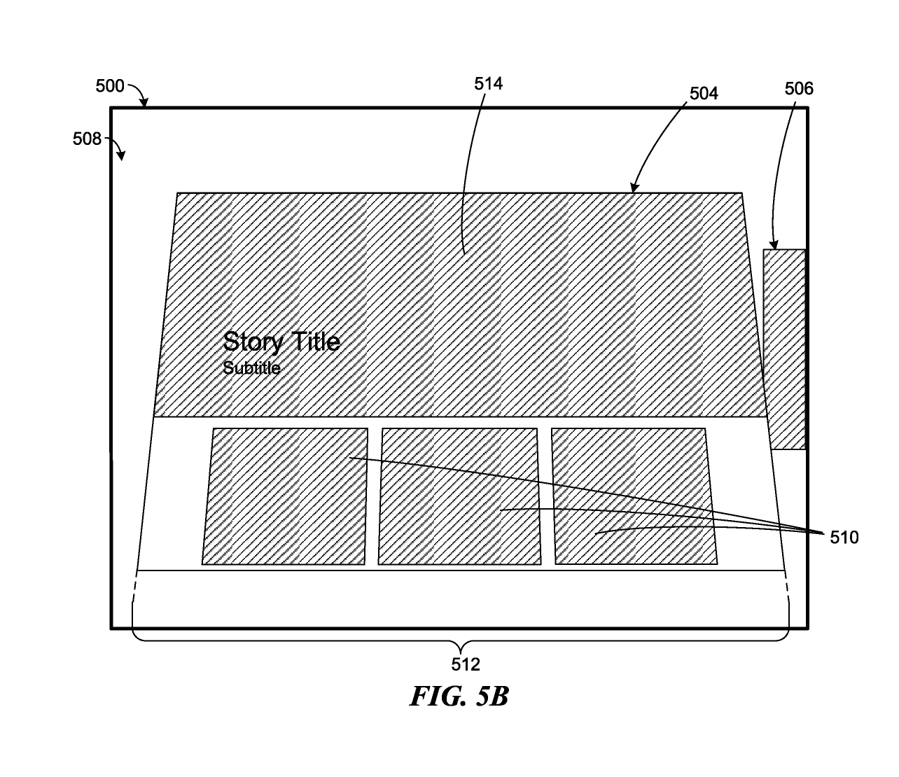

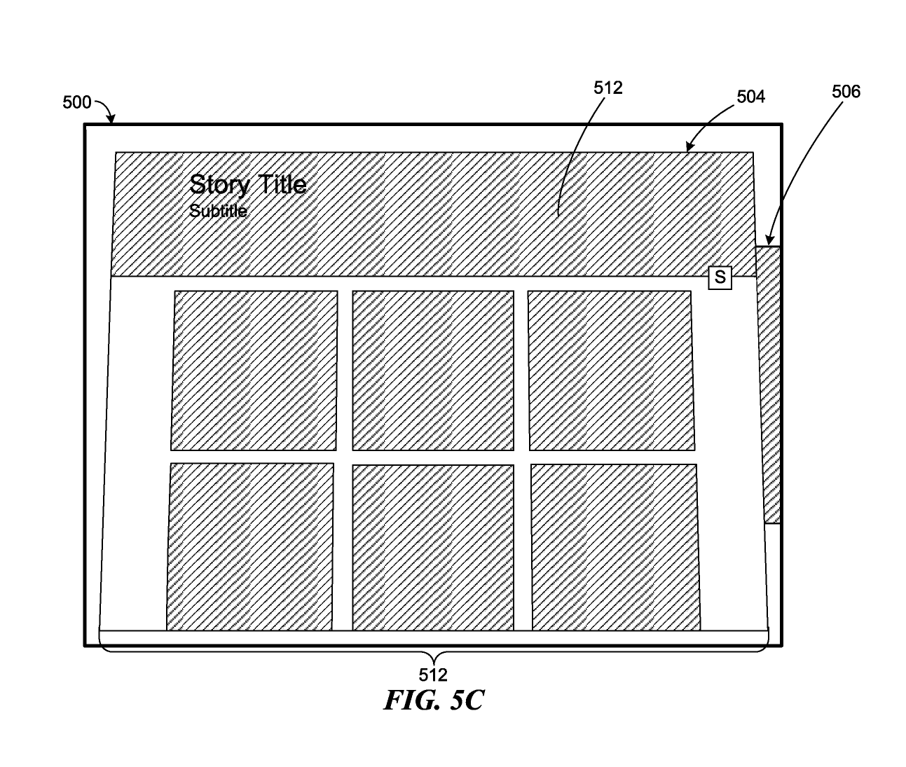

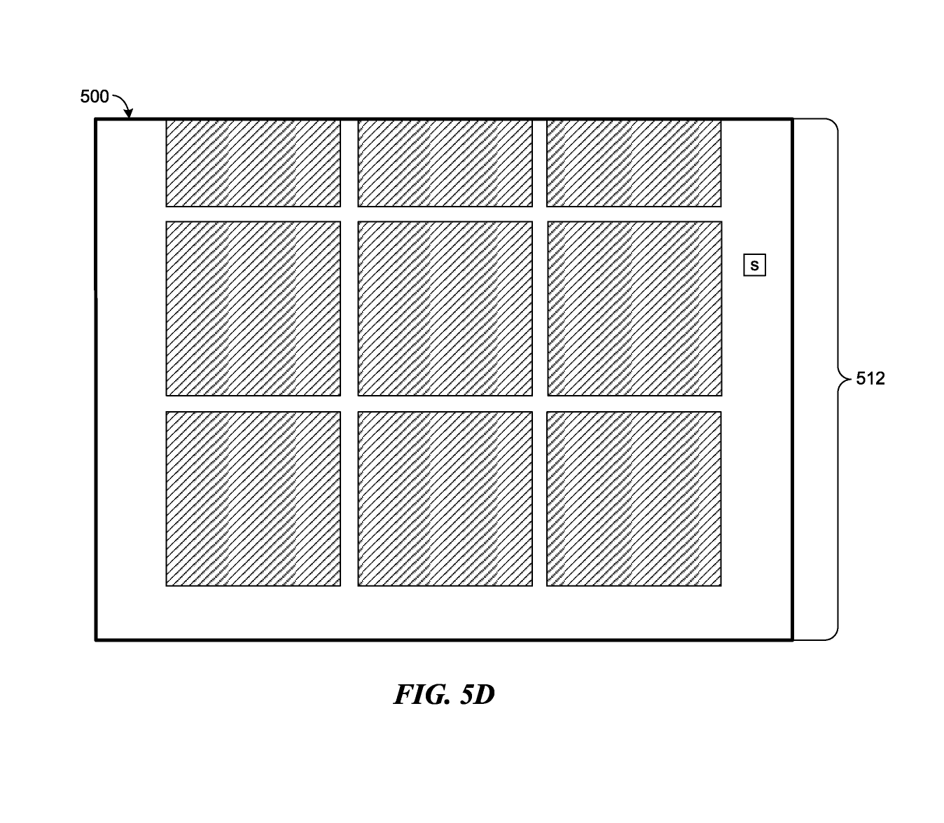

FIGS. 5A-5D are sequential images of the graphical user interface displayed on an electronic device, such as the electronic device 300 of FIG. 3, illustrating a transition sequence from a container shelf layer, such as the container shelf layer 102 of FIG. 1, to a content container layer, such as the content container layer 150, of a content presentation structure, such as the content presentation structure 104 of FIG. 1, consistent with various embodiments.

FIG. 5A illustrates a screen window 500 of the electronic device displaying a portion of a container shelf layer 502. The portion of the container shelf layer 502 includes both a first content container 504 and a second content container 506. For the purposes of this disclosure, the screen window 500 as illustrated in FIG. 5A may be the same as or similar to the screen window 400 as illustrated in FIG. 4B.

FIG. 5A can transition to FIG. 5B through user interaction, such as through user interaction with a touch panel component of the electronic device. For example, when a swipe up or slide up gesture is detected over the first content container 504 on the touch panel component, the electronic device can initiate a sneak preview of the content container layer of the first content container 504, similar to FIG. 4C.

FIG. 5B illustrates the screen window 500 displaying a first transitional frame 508. The first transitional frame 508 may contain both elements of the container shelf layer 502 (not labeled) and the content container layer 512. For example, the first transitional frame 508 contains the first content container 504 (e.g., where a cover 514 of the first content container 504 is shown) and the second content container 506, where both are elements of the container shelf layer 502. The first transitional frame 508 may also contain media objects 510, which are elements of a content container layer 512 for the first content container 504. For purposes of this disclosure, the screen window 500 as illustrated in FIG. 5B may be the same or similar to the screen window 400 as illustrated in FIG. 4C. The content container layer 512 of the first content container 504 is illustrated to tilt into the screen window 500 from the top of the content container layer 512.

FIG. 5B can transition to FIG. 5C through user interaction, such as through user interaction with the touch panel component of the electronic device. For example, when the detected swipe up or slide up gesture continues over the first content container 504 on the touch panel component, the electronic device can trigger a layer transition from the container shelf layer 502 to the content container layer 512 of the first content container 504. The layer transition can be initiated after a threshold duration of the detected gesture or a threshold distance of the detected gesture. In various embodiments, the layer transition may be different from the sneak preview in that once activated and when user input/engagement is released, the layer transition may continue without returning the presentation layer the user is most recently engaged in.

FIG. 5C illustrates the screen window 500 displaying a second transitional frame 514. The second transitional frame 514 may contain both elements of the container shelf layer 502 and the content container layer 512, similar to the first transitional frame 508. As part of the transition sequence, the content container layer 512 of the first content container 504 is illustrated to un-tilt back to the screen window 500 away from the tilted state of the first transitional frame 508. The content container layer 512 is also illustrated to expand to take out more real estate of the screen window 500.

FIG. 5C can transition to FIG. 5D through user interaction, such as the swipe up or slide up gesture as discussed above, or automatically once the layer transition sequence has activated. FIG. 5D illustrates the screen window 500 displaying the content container layer 512 of the first content container 504. The transition sequence can continue to expand the content container layer 512 to fill up the entirety of the screen window 500. The transition sequence can undo the tilt of the display of the content container layer 512 such that the content container layer 512 is displayed on the screen window 500 without tilt.

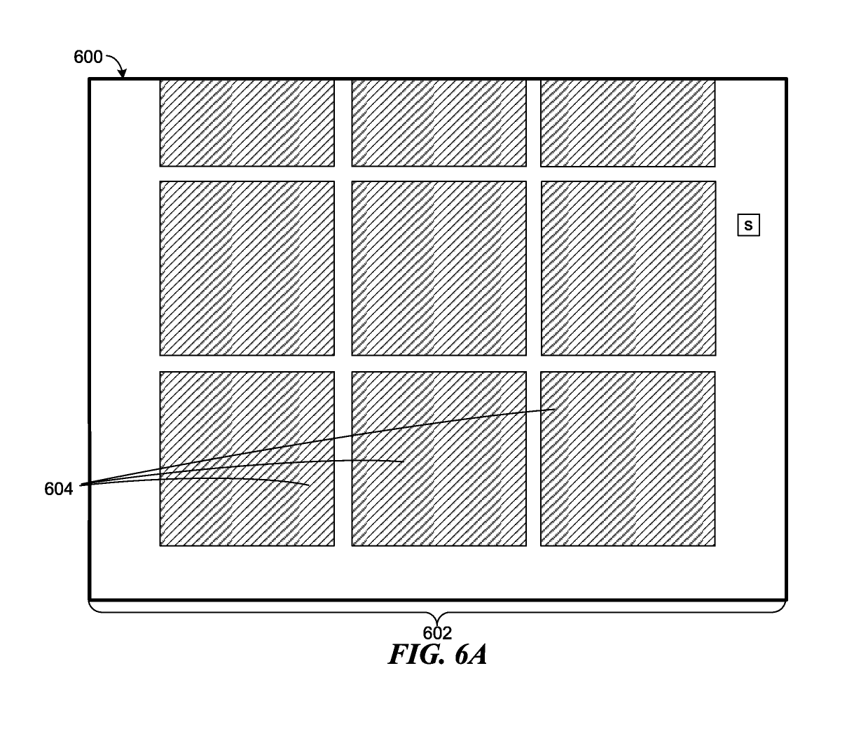

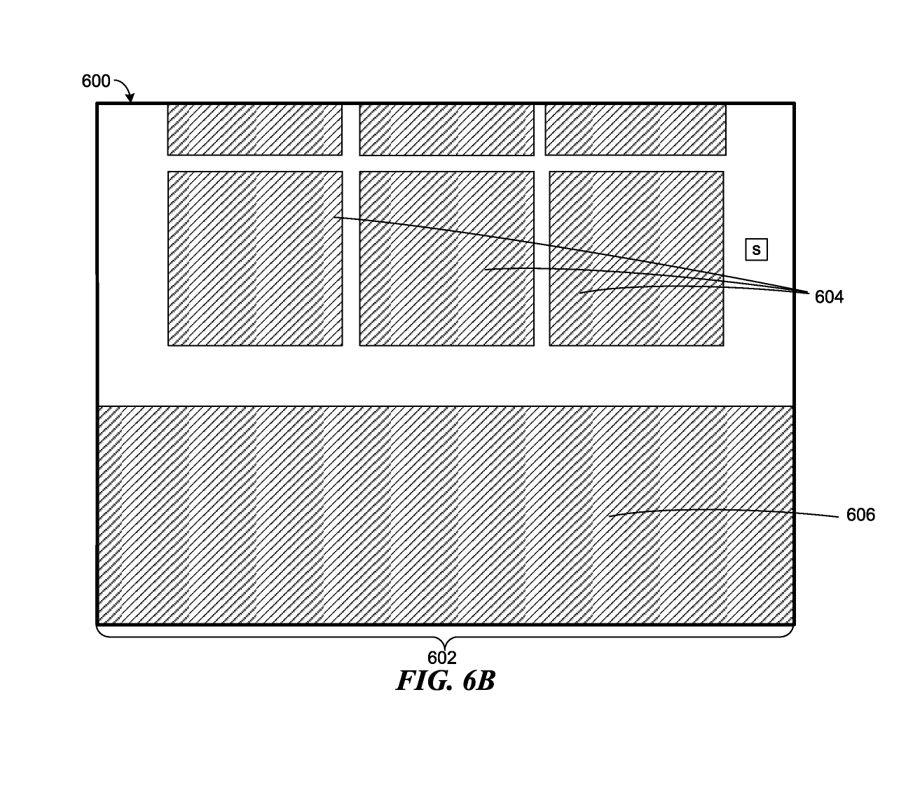

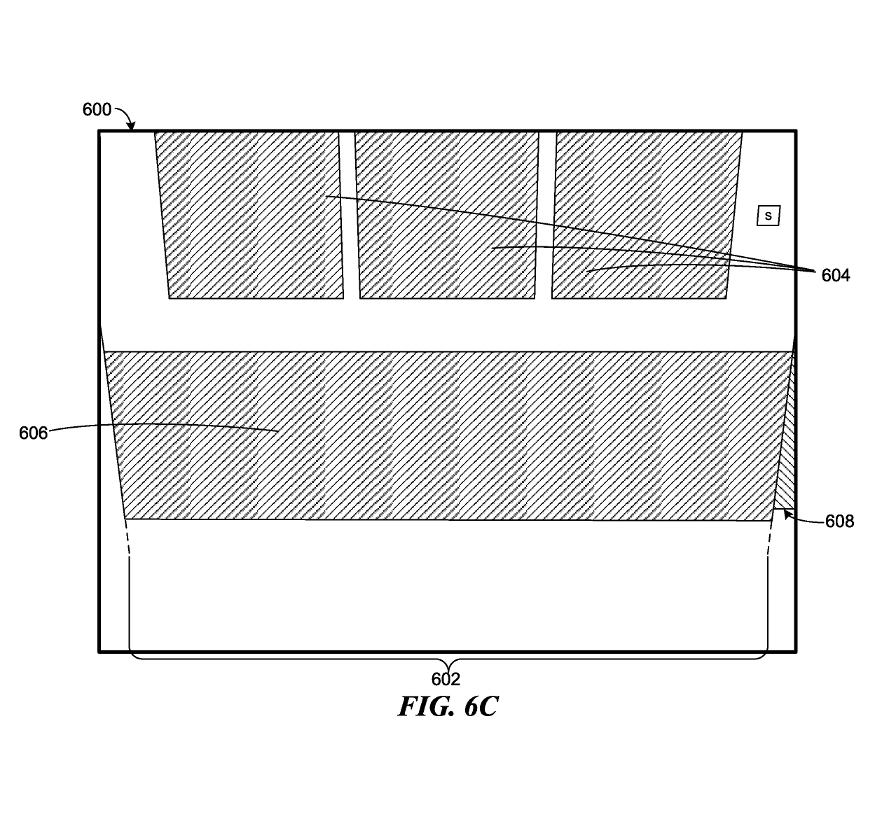

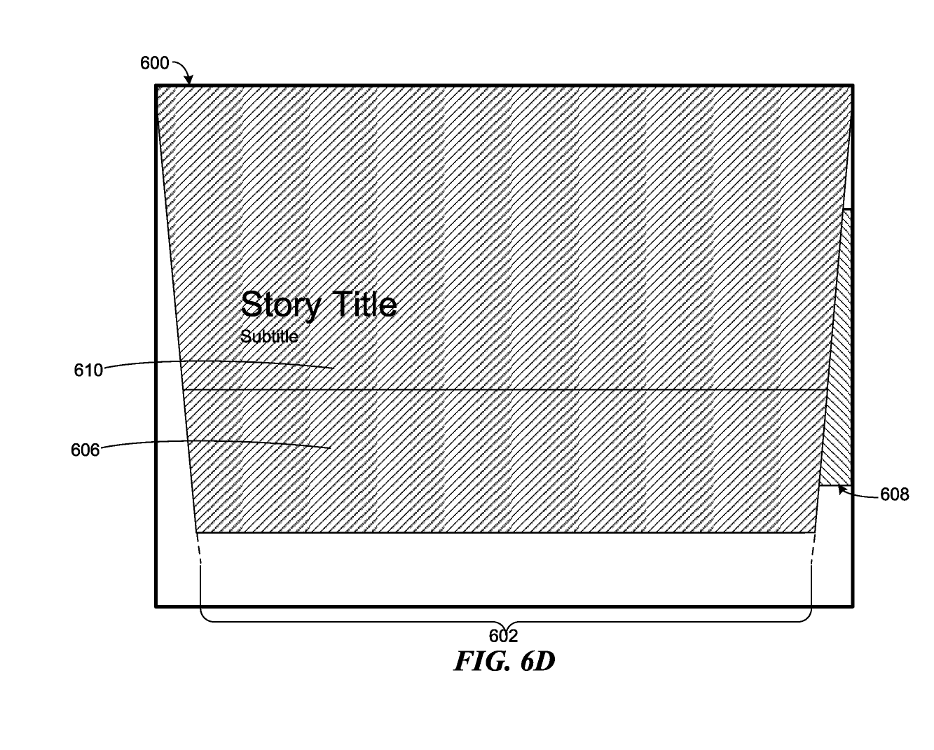

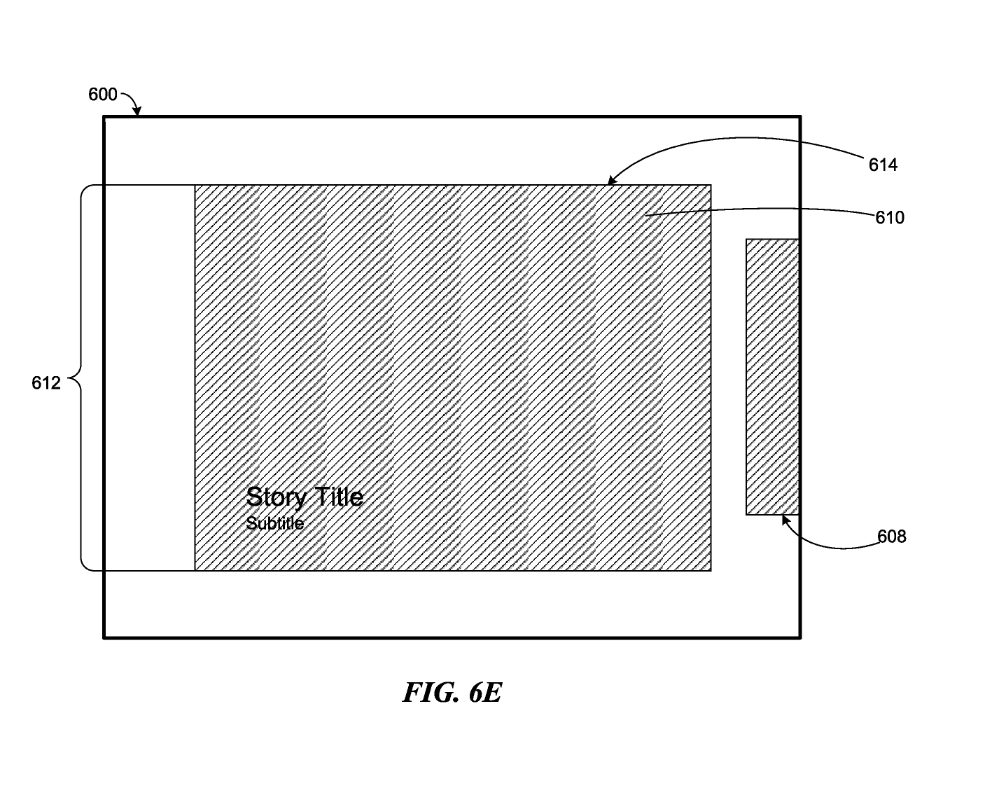

FIGS. 6A-6E are sequential images of the graphical user interface displayed on an electronic device, such as the electronic device 300 of FIG. 3, illustrating a transition sequence from a content container layer, such as the content container layer 150, to a container shelf layer, such as the container shelf layer 102 of FIG. 1, of a content presentation structure, such as the content presentation structure 104 of FIG. 1, consistent with various embodiments.

FIG. 6A illustrates a screen window 600 displaying a portion of a content container layer 602. The content container layer 602 may be a first content container of various content containers accessible to the user. The portion of the content container layer 602 includes one or more media objects 604, such as the media objects 152 of FIG. 1B. FIG. 6A can transition to FIG. 6B through user interaction, such as through user interaction with a touch panel component of an electronic device. For example, when the swipe up or slide up gesture is detected over the content container layer 602 on the touch panel component, the GUI can scroll down through the content container layer 602 to reveal portions that are not shown on the screen window 600.

FIG. 6B illustrates the screen window 600 displaying a portion of the content container layer 602 including a footer 606. The footer 606 can be the last media element of the content container layer 602. The footer 606 can be at the bottom of the content container layer 602. For example, the footer 606 may include text, image, video clip, an interactive widget, or any combination thereof.

FIG. 6B can transition to FIG. 6C through user interaction, such as through user interaction with the touch panel component of the electronic device. For example, when the swipe up or slide up gesture is detected over the content container layer 602 on the touch panel component after the footer 606 is reached, the GUI may initiate a layer transition from the content container layer 602 back to a container shelf layer 612.

FIG. 6C illustrates the screen window 600 displaying a portion of the content container layer 602, where the content container layer 602 is tilted inwards into the screen window 600 from the bottom of the content container layer 602. As a user continues to scroll down through the content container layer 602 (e.g., by performing a swipe up gesture), the transition sequence can initiate. The transition sequence may include tilting of the content container layer 602. The transition sequence may also include a size reduction of the content container layer 602 following the tilting. As an example, the content container layer 602 is shown to be tilted with a slight size reduction. Once the content container layer 602 begins to tilt, elements of the container shelf layer 612 may be shown. For example, a portion of a second content container 608 on the container shelf layer 612 may be shown as illustrated in FIG. 6C.

FIG. 6C can transition to FIG. 6D through user interaction, such as the detected gesture on the touch panel component responsible for the transition from FIG. 6B to FIG. 6C, or automatically in response to the layer transition being initiated. FIG. 6D illustrates the screen window 600 displaying a portion of the content container layer 602 with a cover 610 of the content container layer 602 covering the media objects 604 previously shown. As part of the transition sequence, the cover 610 can slide in from the border of the screen window 600, such as from the top border of the screen window.

FIG. 6D can transition to FIG. 6E through user interaction, such as the detected gesture on the touch panel component responsible for the transition from FIG. 6B to FIG. 6C, or automatically in response to the layer transition being initiated. FIG. 6E illustrates the screen window 600 displaying the container shelf layer 612 after the layer transition completes. As illustrated, the container shelf layer 612 displays an emphasized cover 610 of a first content container 614 and the second content container 608, wherein the first content container 614.

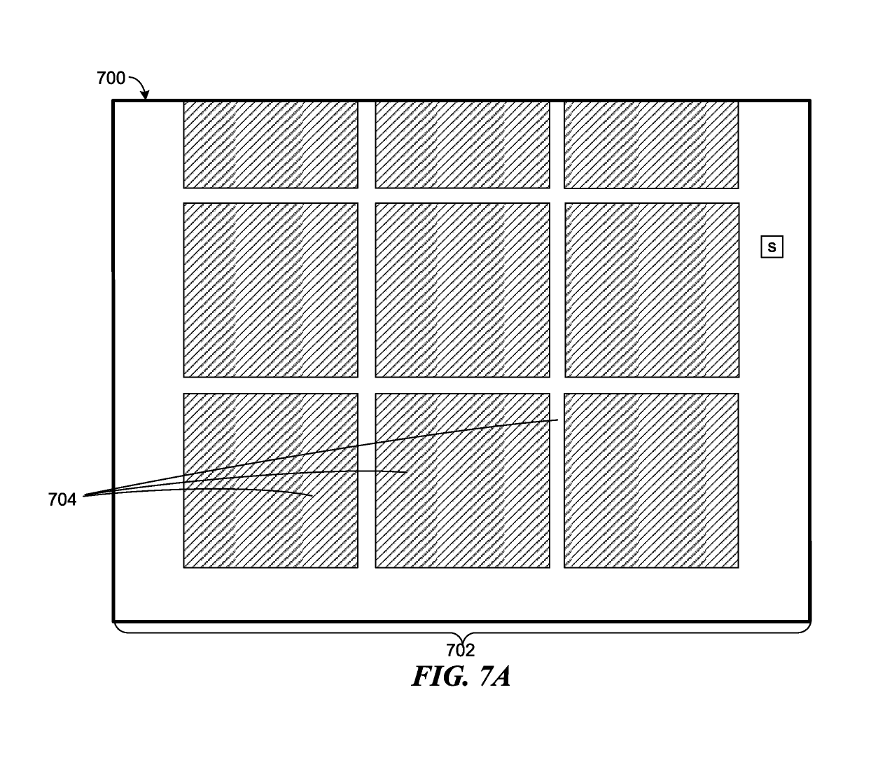

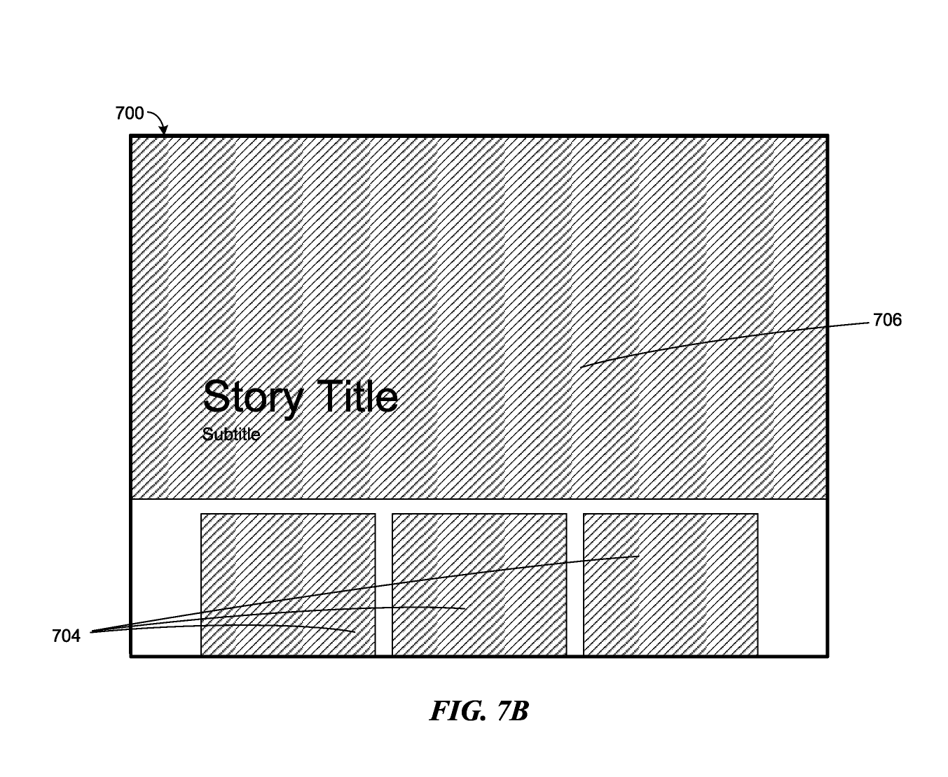

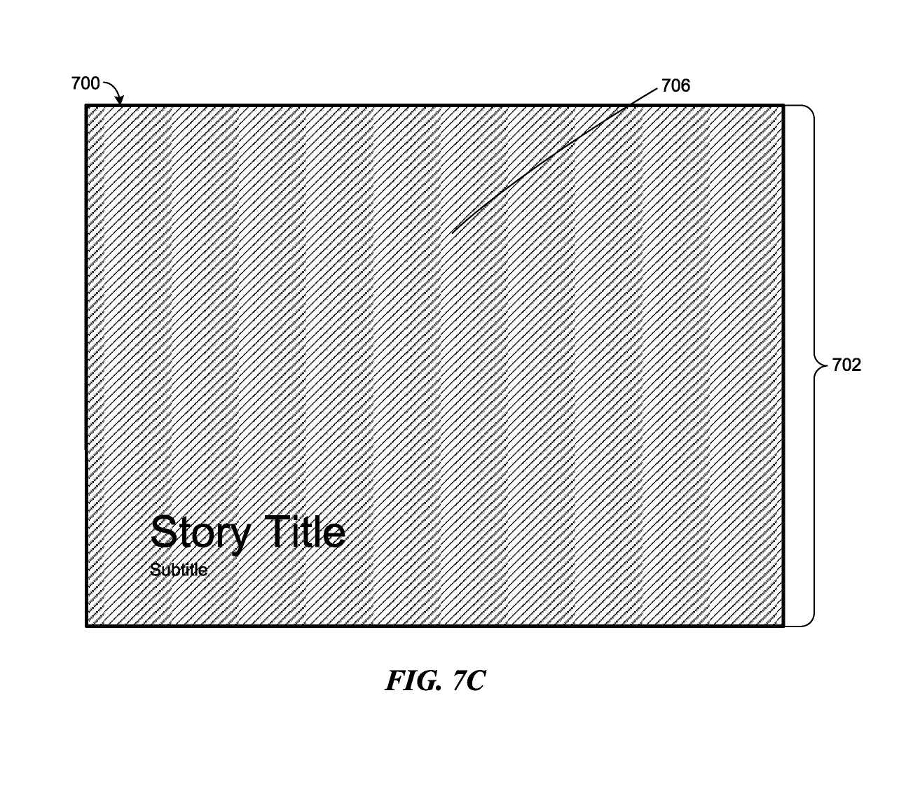

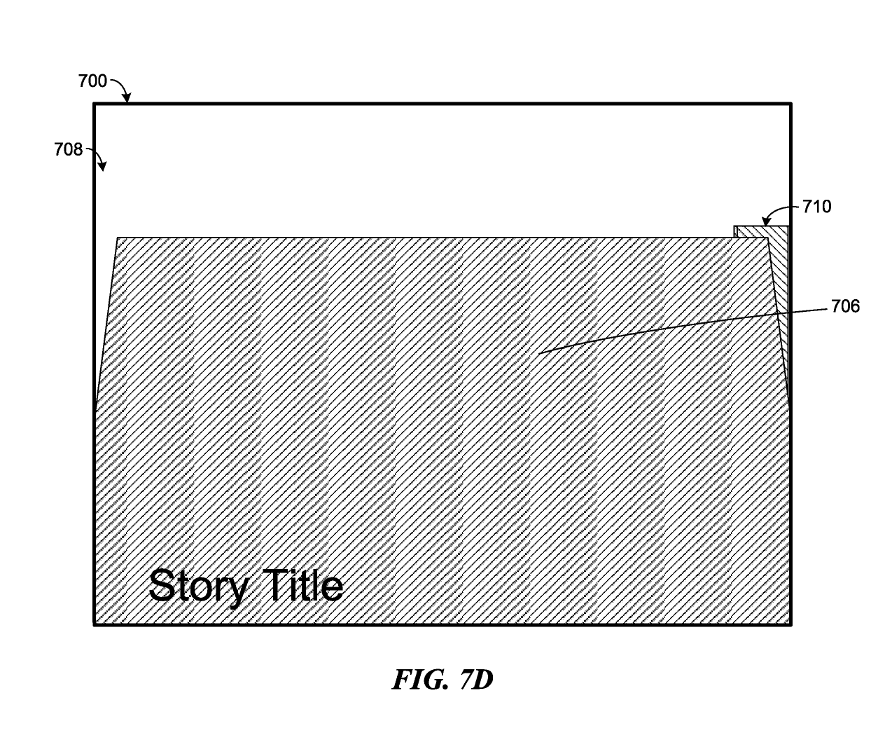

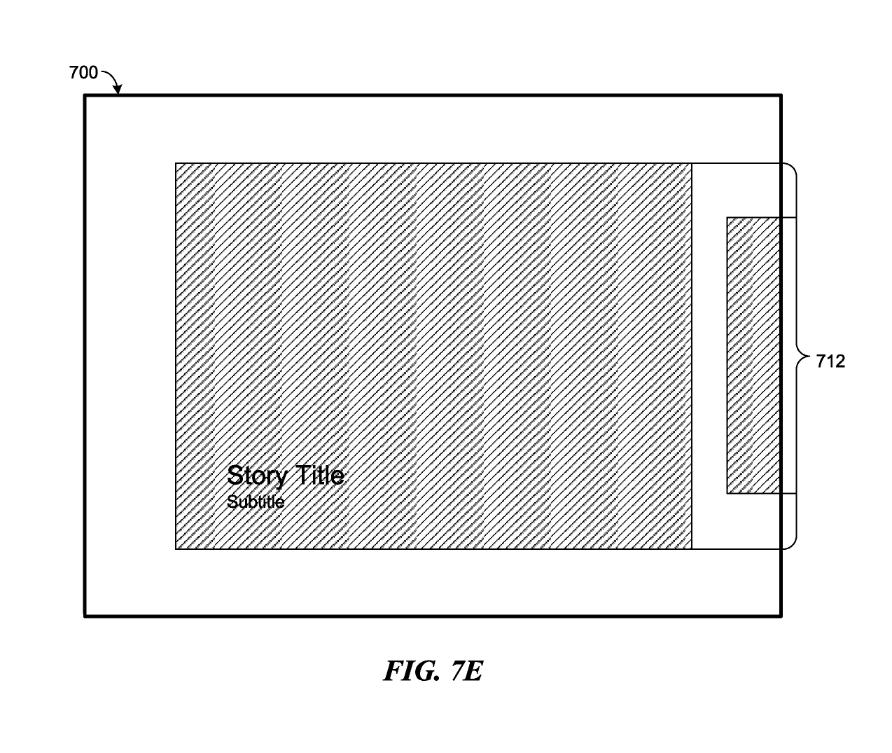

FIGS. 7A-7E are sequential images of the graphical user interface displayed on an electronic device, such as the electronic device 300 of FIG. 3, illustrating another transition sequence from a content container layer, such as the content container layer 150, to a container shelf layer, such as the container shelf layer 102 of FIG. 1, of a content presentation structure, such as the content presentation structure 104 of FIG. 1, consistent with various embodiments.

FIG. 7A illustrates a screen window 700 displaying a portion of a content container layer 702. The content container layer 702 may be a first content container of various content containers accessible to the user. The portion of the content container layer 702 includes one or more media objects 704, such as the media objects 152 of FIG. 1B.

FIG. 7A can transition to FIG. 7B through user interaction, such as through user interaction with a touch panel component of the electronic device. For example, when a swipe down or slide down gesture is detected over the content container layer 702 on the touch panel component, the GUI can scroll up through the content container layer 702 to reveal portions that are not shown on the screen window 700.

FIG. 7B illustrates the screen window 700 displaying a portion of the content container layer 702 including a cover 706. The cover 706 can be the first media element of the content container layer 702. The cover 706 can be at the top of the content container layer 702. For example, the cover 706 may include text, image, video clip, an interactive widget, or any combination thereof.

FIG. 7B can transition to FIG. 7C through user interaction, such as through user interaction with the touch panel component of the electronic device. For example, when the swipe up or slide up gesture is detected over the content container layer 702 on the touch panel component, the GUI can scroll up through the content container layer 702 to reveal the entire cover 706.

FIG. 7C illustrates the screen window 700C displaying the cover 706 of the content container layer 702. In some embodiments, the screen window 700C may be the last navigable frame in the content container layer 702 before the transition sequence of the layer transition begins.

FIG. 7C can transition to FIG. 7D through user interaction, such as through user interaction with the touch panel component of the electronic device. The transition may also be based on continuity of the detected gesture on the touch panel component responsible for the transition from FIG. 7B to FIG. 7C.

FIG. 7D illustrates the screen window 700 displaying a transition frame 708 in mid-transition. For example, the cover 706 may be tilted inward into the screen window 700 from the top of the cover 706. As part of the transition sequence, the cover 706 can reduce in size. In some embodiments, the tilting and the size reduction can occur simultaneously. In other embodiments, the size reduction may occur before or after the tilting sequence begins.

As illustrated, when the cover 706 begins to tilt, a second content container 710 may become visible on the screen window 700. The second content container 710, for example, can be part of the container shelf layer (not labeled) that is beginning to come into view.

FIG. 7D can transition to FIG. 7E through user interaction, such as the detected gesture on the touch panel component responsible for the transition from FIG. 7C to FIG. 7D, or automatically in response to the layer transition being initiated. FIG. 7E illustrates the GUI on the screen window 700 displaying the container shelf layer 712. As illustrated, the container shelf layer 712 displays the cover 706 of a first content container 714 in the center of the screen window 700, emphasized (e.g., in size) over the second content container 710.

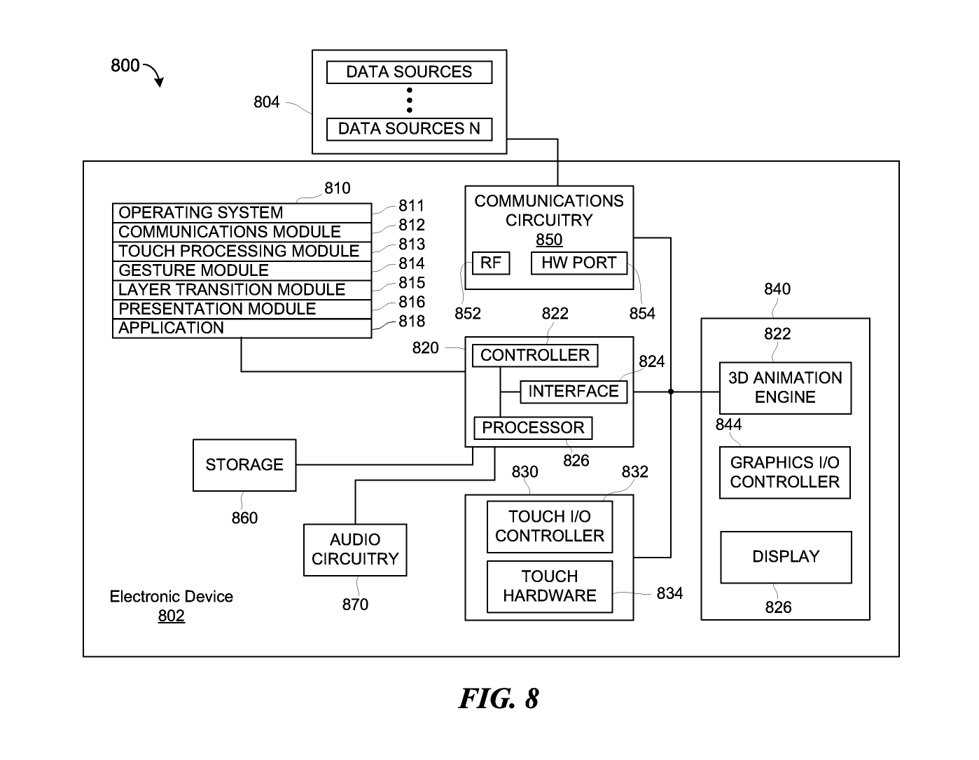

FIG. 8 is a block diagram of a content presentation system 800 including an electronic device 802 and one or more data sources 804, configured in accordance with various embodiments. The electronic device 802 that can include one or more computer-readable mediums 810, processing system 820, touch subsystem 830, display/graphics subsystem 840, communications circuitry 850, storage 860, and audio circuitry 870. These components may be coupled by one or more communication buses or signal lines. The electronic device 802 can be the same as or similar to electronic device 300 of FIG. 3.

The data sources 804 represent the various sources from which content or media objects can be obtained and ultimately displayed on the electronic device 802. The content can be any suitable media such as, for example, printed media, video media, or audio media. Each data source can provide one or more articles or other content assets that can be viewed on the electronic device. The electronic device 802 can obtain content from the data sources 804 on demand or at regular intervals. The content at the data source 804 can update continuously.

It should be apparent that the architecture shown in FIG. 8 is only one example architecture of the content presentation system 800, and that the electronic device 802 could have more or fewer components than shown, or a different configuration of components. The various components shown in FIG. 8 can be implemented in hardware, software, firmware or any combination thereof, including one or more signal processing and/or application specific integrated circuits.

The communications circuitry 850 can include RF circuitry 852 and/or port 854 for sending and receiving information. The RF circuitry 852 permits transmission of information over a wireless link or network to one or more other devices and includes well-known circuitry for performing this function. The port 854 permits transmission of information over a wired link. The communications circuitry 850 can communicate, for example, with the data sources 804. The communications circuitry 850 can be coupled to the processing system 820 via a peripherals interface 824. The peripherals interface 824 can include various known components for establishing and maintaining communication between peripherals and the processing system 820.

The audio circuitry 870 can be coupled to an audio speaker (not shown) and a microphone (not shown) and includes known circuitry for processing voice signals received from the peripherals interface 824 to enable a user to communicate in real-time with other users. In some embodiments, the audio circuitry 870 includes a headphone jack (not shown).

The peripherals interface 824 can couple various peripherals of the system to one or more processors 826 and the computer-readable medium 810. The one or more processors 826 can communicate with one or more computer-readable mediums 810 via a controller 822. The computer-readable medium 810 can be any device or medium that can store code and/or data for use by the one or more processors 826. The medium 810 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). The medium 810 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

The one or more processors 826 can run various software components stored in the medium 810 to perform various functions for the electronic device 802. In some embodiments, the software components include an operating system 811, a communication module (or set of instructions) 812, a touch processing module (or set of instructions) 812, a gesture module (or set of instructions) 814, a layer transition module (or set of instructions) 815, a presentation module (or set of instructions) 816, such as the presentation module 335 of FIG. 3, and one or more applications (or set of instructions) 818. Each of these modules and above noted applications correspond to a set of instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules may be combined or otherwise rearranged in various embodiments. In some embodiments, the medium 810 may store a subset of the modules and data structures identified above. Furthermore, the medium 810 may store additional modules and data structures not described above.

The operating system 811 can include various procedures, sets of instructions, software components and/or drivers for controlling and managing general system tasks (e.g., memory management, storage device control, power management, etc.) and facilitates communication between various hardware and software components.

The communication module 812 facilitates communication with other devices using the communications circuitry 850 and includes various software components for handling data received from the RF circuitry 852 and/or the port 854.

The touch processing module 813 includes various software components for performing various tasks associated with touch hardware 834 including but not limited to receiving and processing touch input received from the I/O device 830 via a touch I/O device controller 832. For example, the touch processing module 813 can also include software components for performing tasks associated with other I/O devices (not shown).

Gesture, layer transition, and presentation modules 814-816 include instructions for performing different flip transition animations in accordance with various embodiments of the invention. The modules 814-816 may use data provided by other modules within the medium 810 or operate in concert with the modules to execute transition animations.

The gesture module 814 can determine characteristics of touch inputs through the touch processing module 813. For example, the gesture module 814 can be coupled to the presentation module 816 to associate gesture patterns with commands to interact with a content presentation structure, such as the content presentation structure 104 of FIG. 1. For example, the transition sequences rendered by the layer transition module 815 may be based on gesture analysis processed by the gesture module 814. For example, the gesture module 814 can determine the speed at which the transition sequence is to perform. As another example, the gesture module 814 can determine whether sufficient momentum is present (based on the input gesture) to enable the transition sequence to occur.

The layer transition module 815 is configured to control the transition sequence based on data provided by the gesture module 814, the touch processing module 813, and the presentation module 816. The layer transition module 815 can include various known software components for rendering, animating and displaying graphical objects on a display surface. In embodiments, in which the touch hardware 834 is a touch sensitive display (e.g., touch screen), the layer transition module 815 includes components for rendering, displaying, and animating objects on the touch sensitive display. More particularly, the layer transition module 815 can provide animation instructions to a 3D animation engine 842, which can render the graphics and provide the rendering to graphics I/O controller 844, so that the graphics I/O controller 844 can display the graphics on display 846.

The presentation module 816 includes instructions for providing a GUI that enables the user to navigate through the content presentation structure in accordance with various embodiments. The presentation module 816 may be coupled to the layer transition module 815 to determine when a layer transition should occur. The layer transition module 815 can then provide the transition sequence for the specific layer transition. Once the layer transition is completed, the GUI can continue to provide the user to navigate through the content presentation structure at a different presentation layer.

One or more applications 819 can include any applications installed on the electronic device 802, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

The touch I/O controller 832 is coupled to the touch hardware 834 for controlling or performing various functions. The touch hardware 832 communicates with the processing system 820 via the touch I/O device controller 832, which includes various components for processing user touch input (e.g., scanning hardware). One or more other input controllers (not shown) receives/sends electrical signals from/to other I/O devices (not shown). Other I/O devices may include physical buttons, dials, slider switches, sticks, keyboards, touch pads, additional display screens, or any combination thereof.

If embodied as a touch screen, the touch hardware 834 displays visual output to the user in a GUI. The visual output may include text, graphics, video, and any combination thereof. Some or all of the visual output may correspond to user-interface objects. The touch hardware 834 forms a touch-sensitive surface that accepts touch input from the user. The touch hardware 834 and the touch controller 832 (along with any associated modules and/or sets of instructions in the medium 810) detects and tracks touches or near touches (and any movement or release of the touch) on the touch hardware 834 and converts the detected touch input into interaction with graphical objects, such as one or more user-interface objects. In the case in which the touch hardware 834 and the display 825 are embodied as a touch screen, the user can directly interact with graphical objects that are displayed on the touch screen. Alternatively, in the case in which hardware 834 is embodied as a touch device other than a touch screen (e.g., a touch pad), the user may indirectly interact with graphical objects that are displayed on a separate display screen.

Embodiments in which the touch hardware 834 is a touch screen, the touch screen may use LCD (liquid crystal display) technology, LPD (light emitting polymer display) technology, OLED (organic light emitting diode), or OEL (organic electro luminescence), although other display technologies may be used in other embodiments.

Feedback may be provided by the touch hardware 834 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

In some embodiments, the peripherals interface 824, the one or more processors 826, and the memory controller 822 may be implemented on a single chip. In some other embodiments, they may be implemented on separate chips. The storage 860 can any suitable medium for storing data, including, for example, volatile memory (e.g., cache, RAM), non-volatile memory (e.g., Flash, hard-disk drive), or a both for storing data, including pages used for transition animations.

Blocks, components, and/or modules associated with the electronic device 300 or the electronic device 802 may be implemented as hardware modules, software modules, or any combination thereof. For example, the modules described can be software modules implemented as instructions on a tangible storage memory capable of being executed by a processor or a controller on a machine. The tangible storage memory may be a volatile or a non-volatile memory. In some embodiments, the volatile memory may be considered “non-transitory” in the sense that it is not a transitory signal. Software modules may be operable when executed by a processor or other computing device, e.g., a single board chip, application specific integrated circuit, a field programmable field array, a network capable computing device, a virtual machine terminal device, a cloud-based computing terminal device, or any combination thereof.

Each of the modules may operate individually and independently of other modules. Some or all of the modules may be executed on the same host device or on separate devices. The separate devices can be coupled via a communication module to coordinate its operations via an interconnect or wirelessly. Some or all of the modules may be combined as one module.

A single module may also be divided into sub-modules, each sub-module performing separate method step or method steps of the single module. In some embodiments, the modules can share access to a memory space. One module may access data accessed by or transformed by another module. The modules may be considered “coupled” to one another if they share a physical connection or a virtual connection, directly or indirectly, allowing data accessed or modified from one module to be accessed in another module. In some embodiments, some or all of the modules can be upgraded or modified remotely. The electronic device 300 or the electronic device 802 may include additional, fewer, or different modules for various applications.

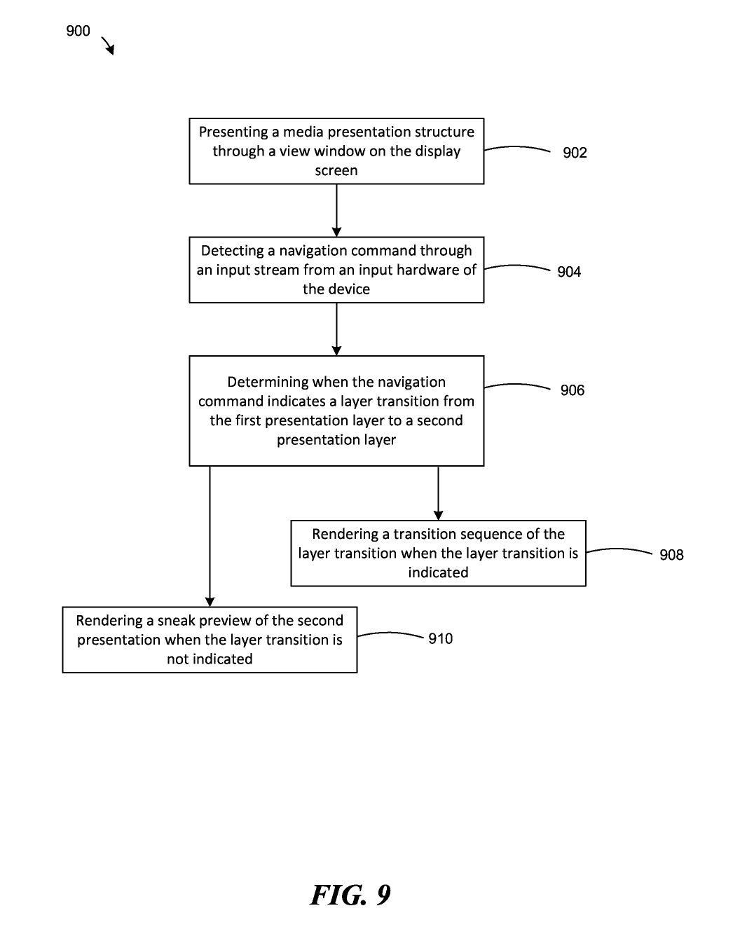

FIG. 9 is a flow chart illustrating a method 900 of navigating through a content presentation structure, such as the content presentation structure 104 of FIG. 1, consistent with various embodiments. The method 900 may be executed by the presentation module 816 and/or the layer transition module 815.

The method 900 may include presenting a media presentation structure through a view window on the display screen of the device at a step 902. The media presentation structure, such as the content presentation structure 104 of FIG. 1, includes multiple presentation layers. The multiple presentation layers of the media presentation structure may be organized hierarchically enabling navigation from one layer down or up to another hierarchically. Presenting the media presentation structure may include rendering the first presentation layer in a three dimensional space and presenting the second presentation layer in a two dimensional space, or vice versa. The presentation layers may include a first presentation layer primarily navigable along a first dimension through a touch screen, such as the display screen, and a second presentation layer primarily navigable along a second dimension orthogonal to the first dimension. For example, the step 902 may be implemented by the presentation module 816.

The method 900 may then include detecting a navigation command through an input stream from an input hardware of the device at a step 904. For example, the step 904 may be implemented by the gesture module 814 or the touch processing module 813. The navigation command may enable the view window to traverse through presentation of the first presentation layer of the media presentation structure. In various embodiments, detecting the navigation command includes detecting a gesture through a touch event stream from the touchscreen of the device while the media presentation structure is engaged in a first presentation layer of the multiple presentation layers.

The method 900 then includes determining when the navigation command indicates a layer transition from the first presentation layer to a second presentation layer at a step 906. The step 906 may be implemented by the layer transition module 815. For example, the layer transition is indicated by determining whether the navigation command exceeds a limit of the first presentation layer. The limit may include a zoom limit and/or a navigable boundary.

In various embodiments, determining when the navigation command indicates the layer transition is based on a characteristic of the gesture and a position of the first presentation layer relative to the view window. As an example, the gesture may be a swiping gesture and the first presentation layer may be navigable along a first dimension. In the example, determining whether the layer transition occurs may be by: calculating a traversal vector based on a motion of the gesture; and determining whether the traversal vector is orthogonal to the first dimension of navigation for first presentation layer. Determining whether the layer transition occurs may also be by: determining whether the layer transition occurs is by: calculating a navigational movement to scroll through the first presentation layer relative to the view window based on a motion of the gesture; and determining whether a boundary of the first presentation layer is bordering the view window and that the navigational movement moves the boundary within the view window.

As another example, the gesture may be a pinching gesture associated with a zoom command. In this example, determining whether the layer transition occurs may be by determining whether the zoom command exceeds a zooming boundary of the first presentation layer. In this example, when the layer transition is indicated, the position of the first presentation layer relative to the view window is bookmarked by the electronic device such that a subsequent layer transition back to the first presentation layer would return a user to the same bookmarked position.

When the layer transition is indicated, a transition sequence of the layer transition is rendered at a step 908. The step 908 may be implemented by the layer transition module 815. The transition sequence may be a gradual shift between the first and second presentation layers. The transition sequence may include animating a shared element included in both the first presentation layer and the second presentation layer. The transition sequence may include re-sizing display of the first presentation layer. The transition sequence may include sliding a cover over the first presentation layer. The transition sequence may include resizing at least a portion of the first presentation layer such that elements of both the first presentation layer and the second presentation layer is visible during the transition sequence.

Rendering the transition sequence may include rendering either the first or second presentation layer as a two dimensional sheet in a three dimensional space and tilting either the first or the second presentation layer in the three dimensional space. In various embodiments, the transition sequence is rendered when continuous user engagement is detected from the input stream for a pre-determined duration of the transition sequence.

When the layer transition is not indicated, a sneak preview of the second presentation layer may be rendered for a duration of the gesture at a step 910. The step 908 may be implemented by the presentation module 816.

While processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

### Terminology

Each section or figure of this disclosure may exemplify different implementations and relationships between elements and terms. However, similar elements and terms referred in the different sections of this disclosure and the drawings are meant to be consistent with each other.

Alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Terms of orientation in describing the GUI of this disclosure are for illustrative purposes only. For example, a “horizontal” or a “vertical” motion, gesture, traversal referred to any dimension within a two-dimensional or three-dimensional coordinate system.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, titles or subtitles may be used in the examples for convenience of a reader, which in no way should limit the scope of the disclosure. Also for convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element can be described in more than one way.

Those of skill in the art will appreciate that the invention may be embodied in other forms and manners not shown below. It is understood that the use of relational terms, if any, such as first, second, top, and bottom, and the like are used solely for distinguishing one entity or action from another, without necessarily requiring or implying any such actual relationship or order between such entities or actions.

### Clarification of Description

The teachings of the disclosure provided herein can be applied to other systems, not necessarily the system described above. The elements and acts of the various embodiments described above can be combined to provide further embodiments. The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Several embodiments of the described technology are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that may store instructions that implement at least portions of the described technology. In addition, the data structures and message structures may be stored or transmitted via a data transmission medium, such as a signal on the communications link. Various communications links may be used, such as the Internet, a local area network, a wide area network, or a point-to-point dial-up connection. Thus, the computer-readable media can comprise computer-readable storage media (e.g., “non-transitory” media) and computer-readable transmission media.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

What is claimed is:

1. A method, implemented on a device having a touchscreen, comprising:
presenting a media presentation structure through a view window on the touch screen of the device, wherein the media presentation structure includes multiple presentation layers;
detecting a gesture through a touch event stream from the touchscreen of the device while the media presentation structure is engaged in a first presentation layer of the multiple presentation layers;
determining whether a layer transition occurs based on a characteristic of the gesture and a position of the first presentation layer relative to the view window; and
rendering a transition sequence when the layer transition is indicated, wherein the transition sequence includes resizing at least a portion of the first presentation layer such that elements of both the first presentation layer and a second presentation layer is visible during the transition sequence.

2. The method of claim 1, wherein the gesture is a swiping gesture; wherein the first presentation layer is navigable along a first dimension; and wherein determining whether the layer transition occurs is by:
calculating a traversal vector based on a motion of the gesture; and
determining whether the traversal vector is orthogonal to the first dimension of navigation for first presentation layer.

3. The method of claim 1, wherein the gesture is a swiping gesture; wherein the first presentation layer is navigable along a first dimension; wherein determining whether the layer transition occurs is by:
calculating a navigational movement to scroll through the first presentation layer relative to the view window based on a motion of the gesture; and
determining whether a boundary of the first presentation layer is bordering the view window and that the navigational movement moves the boundary within the view window.

4. The method of claim 1, wherein the gesture is a pinching gesture associated with a zoom command; wherein determining whether the layer transition occurs is by determining whether the zoom command exceeds a zooming boundary of the first presentation layer.

5. The method of claim 1, further comprising rendering a sneak preview of the second presentation layer for a duration of the gesture when the layer transition is not indicated.

6. The method of claim 1, wherein the multiple presentation layers includes a container shelf layer presenting at least a content container as an element and a content container layer presenting at least a cover and a media object as elements; wherein the transition sequence visualizes a gradual shift between the container shelf layer and the content container layer.

7. A method, implemented on a device having a display screen, comprising:
presenting a media presentation structure through a view window on the display screen of the device, wherein the media presentation structure includes multiple presentation layers;
detecting a navigation command through an input stream from an input hardware of the device, wherein the navigation command enables the view window to traverse through presentation of a first presentation layer of the media presentation structure;
determining when the navigation command indicates a layer transition from the first presentation layer to a second presentation layer by determining whether the navigation command exceeds a limit of the first presentation layer; and
rendering a transition sequence of the layer transition when the layer transition is indicated.

8. The method of claim 7, wherein the multiple presentation layers of the media presentation structure is organized hierarchically enabling navigation from one layer down or up to another hierarchically.

9. The method of claim 7, wherein the transition sequence includes animating a shared element included in both the first presentation layer and the second presentation layer.

10. The method of claim 7, wherein rendering the transition sequence includes re-sizing display of the first presentation layer.

11. The method of claim 7, wherein rendering the transition sequence includes sliding a cover over the first presentation layer.

12. The method of claim 7, wherein rendering the transition sequence includes rendering the first presentation layer as a two dimensional sheet in a three dimensional space and tilting the first presentation layer in the three dimensional space.

13. The method of claim 7, wherein rendering the transition sequence includes rendering the second presentation layer as a two dimensional sheet in a three dimensional space and tilting the second presentation layer in the three dimensional space.

14. The method of claim 7, wherein the transition sequence is rendered when continuous user engagement is detected from the input stream for a pre-determined duration of the transition sequence.

15. The method of claim 7, wherein presenting the media presentation structure includes rendering the first presentation layer in a three dimensional space and presenting the second presentation layer in a two dimensional space, or vice versa.

16. The method of claim 7, wherein the first presentation layer includes a cover page; and wherein the transition sequence includes tilting and re-sizing of the cover page.

17. A content presentation system comprising:
a computer-readable storage medium storing instructions;
wherein the instructions, when executed by a processor, are configured to:
present a media presentation structure through a view window on the display screen of the device, wherein the media presentation structure includes multiple presentation layers;
detect a navigation command through an input stream from an input hardware of the device, wherein the navigation command enables the view window to traverse through presentation of a first presentation layer of the media presentation structure;
determine when the navigation command indicates a layer transition from the first presentation layer to a second presentation layer by determining whether the navigation command exceeds a virtual limit of the first presentation layer; and
render a transition sequence of the layer transition when the layer transition is indicated.

18. The content presentation system of claim 17, wherein the transition sequence includes tilting a content container cover in the first presentation layer when resizing the content container cover.

19. The content presentation system of claim 17, further comprising a touch screen to detect a touch event stream on the content presentation system; and wherein the navigation command is associated with a gesture determined from the touch event stream.

20. The content presentation system of claim 19, wherein the first presentation layer is primarily navigable along a first dimension through the touch screen and the second presentation layer is primarily navigable along a second dimension orthogonal to the first dimension.
